(19) United States
(12) Patent Application Publication
(10) Pub. No.: US 2024/0250704 A1
(43) Pub. Date: Jul. 25, 2024

(54) LOW-COMPLEXITY AMPLITUDE ERROR CORRECTION IN A WIRELESS COMMUNICATION CIRCUIT

(71) Applicant: Qorvo US, Inc., Greensboro, NC (US)

(72) Inventor: Nadim Khlat, Cugnaux (FR)

(21) Appl. No.: 18/394,320

(22) Filed: Dec. 22, 2023

Related U.S. Application Data
(60) Provisional application No. 63/480,785, filed on Jan. 20, 2023.

(51) Int. Cl. H04B 1/04; H04B 1/76

(52) U.S. Cl. CPC H04B 1/04; H04B 1/76; H04B 2001/0425

(57) ABSTRACT

Low-complexity amplitude and phase (AM-PM) error correction in a transceiver circuit is provided. In embodiments disclosed herein, a transceiver circuit is configured to equalize an input vector to thereby correct an AM-AM error across a modulation bandwidth of the wireless communication circuit. Unlike conventional methods where complicated memory digital predistortion (mDPD) coefficients must be defined and calibrated for each modulation frequency within the modulation bandwidth, the transceiver circuit is configured herein to eliminate modulation frequency dependency of the AM-AM error. As a result, it is possible to correct the AM-AM error across the modulation bandwidth with reduced complexity to thereby improve efficiency and linearity of the wireless communication circuit.

### RELATED APPLICATIONS

This application claims the benefit of U.S. provisional patent application Ser. No. 63/480,785, filed on Jan. 20, 2023, the disclosure of which is hereby incorporated herein by reference in its entirety.

### FIELD OF THE DISCLOSURE

The technology of the disclosure relates generally to correcting an amplitude-amplitude (AM-AM) error in a wireless communication circuit.

### BACKGROUND

Mobile communication devices have become increasingly common in current society for providing wireless communication services. The prevalence of these mobile communication devices is driven in part by the many functions that are now enabled on such devices. Increased processing capability in such devices means that mobile communication devices have evolved from being pure communication tools into sophisticated mobile multimedia centers that enable enhanced user experiences.

The redefined user experience relies on higher data rates offered by advanced fifth generation (5G) and 5G new radio (5G-NR) technologies, which typically transmit and receive radio frequency (RF) signals in millimeter wave spectrums. Given that the RF signals are more susceptible to attenuation and interference in the millimeter wave spectrums, the RF signals are typically amplified by state-of-the-art power amplifiers to help boost the RF signals to a higher power before transmission.

In a typical wireless communication circuit, a transceiver circuit is configured to generate an RF signal, a power management circuit is configured to generate a modulated voltage, a power amplifier circuit is configured to amplify the RF signal based on the modulated voltage, and an antenna circuit is configured to transmit the RF signal in one or more transmission frequencies. The power amplifier circuit can be further coupled to the antenna circuit via an RF frontend circuit (e.g., filter, switches, etc.). Notably, an output reflection coefficient (e.g., S₂₂) of the power amplifier circuit can interact with an input reflection coefficient (e.g., S₁₁) of the RF frontend circuit to cause a group delay in the RF signal to potentially create an amplitude-to-amplitude (AM-AM) error in the modulated voltage. As such, it is desirable to correct the AM-AM error in all of the transmission frequencies to help prevent undesired amplitude distortion, particularly when the RF signal is modulated across a wide modulation bandwidth (e.g., ≥200 MHZ).

### SUMMARY

Embodiments of the disclosure relate to low-complexity amplitude error correction in a wireless communication circuit. The wireless communication circuit includes a transceiver circuit, a power management integrated circuit (PMIC), and a power amplifier circuit(s). The transceiver circuit generates a radio frequency (RF) signal(s) from an input vector, the PMIC generates a modulated voltage, and the power amplifier circuit(s) amplifies the RF signal(s) based on the modulated voltage. When the power amplifier circuit(s) is coupled to an RF frontend circuit (e.g., filter/multiplexer), an output reflection coefficient (e.g., S₂₂) of the power amplifier circuit(s) can interact with an input reflection coefficient (e.g., S₁₁) of the RF frontend circuit to create a voltage distortion filter on an output stage of the power amplifier circuit(s), which can cause an unwanted amplitude-amplitude (AM-AM) error across a modulation bandwidth of the wireless communication circuit.

In this regard, in embodiments disclosed herein, the transceiver circuit is configured to equalize the input vector to thereby correct the AM-AM error across the modulation bandwidth. Unlike conventional methods where complicated memory digital predistortion (mDPD) coefficients must be defined and calibrated for each modulation frequency within the modulation bandwidth, the transceiver circuit is configured herein to eliminate modulation frequency dependency of the AM-AM error. As a result, it is possible to correct the AM-AM error across the modulation bandwidth with reduced complexity to thereby improve efficiency and linearity of the wireless communication circuit.

In one aspect, a transceiver circuit is provided. The transceiver circuit includes a frequency equalization circuit. The frequency equalization circuit is configured to apply a frequency equalization filter to an input vector to linearize a gain error of the input vector in each of multiple modulation frequencies to thereby generate a frequency-equalized input vector. The transceiver circuit also includes a gain error correction circuit. The gain error correction circuit is configured to apply a complex filter to the frequency-equalized input vector to superimpose a respective linearized gain error in a selected modulation frequency among the multiple modulation frequencies onto a respective linearized gain error in a reference modulation frequency among the multiple modulation frequencies. The gain error correction circuit is also configured to determine a linearized gain error correction term in the selected modulation frequency based on the respective linearized gain error in the reference modulation frequency. The gain error correction circuit is also configured to apply the determined linearized gain error correction term to the frequency-equalized input vector to thereby generate an equalized input vector in the selected modulation frequency.

In another aspect, a wireless device is provided. The wireless device includes a transceiver circuit. The transceiver circuit includes a frequency equalization circuit. The frequency equalization circuit is configured to apply a frequency equalization filter to an input vector to linearize a gain error of the input vector in each of multiple modulation frequencies to thereby generate a frequency-equalized input vector. The transceiver circuit also includes a gain error correction circuit. The gain error correction circuit is configured to apply a complex filter to the frequency-equalized input vector to superimpose a respective linearized gain error in a selected modulation frequency among the multiple modulation frequencies onto a respective linearized gain error in a reference modulation frequency among the multiple modulation frequencies. The gain error correction circuit is also configured to determine a linearized gain error correction term in the selected modulation frequency based on the respective linearized gain error in the reference modulation frequency. The gain error correction circuit is also configured to apply the determined linearized gain error correction term to the frequency-equalized input vector to thereby generate an equalized input vector in the selected modulation frequency.

In another aspect, a method for correcting an amplitude error in a wireless device is provided. The method includes applying a frequency equalization filter to an input vector to linearize a gain error of the input vector in each of multiple modulation frequencies to thereby generate a frequency-equalized input vector. The method also includes applying a complex filter to the frequency-equalized input vector to superimpose a respective linearized gain error in a selected modulation frequency among the multiple modulation frequencies onto a respective linearized gain error in a reference modulation frequency among the multiple modulation frequencies. The method also includes determining a linearized gain error correction term in the selected modulation frequency based on the respective linearized gain error in the reference modulation frequency. The method also includes applying the determined linearized gain error correction term to the frequency-equalized input vector to thereby generate an equalized input vector in the selected modulation frequency.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 is a schematic diagram of an exemplary wireless communication circuit, wherein an unwanted voltage distortion filter may cause an amplitude-amplitude (AM-AM) error in a power amplifier circuit when the power amplifier circuit is coupled to a radio frequency (RF) frontend circuit;

FIG. 2 is a graphic diagram illustrating a distribution of the AM-AM error across a modulation bandwidth of the wireless communication circuit of FIG. 1;

FIG. 3 is a graphic diagram illustrating a low-complexity AM-AM error correction scheme that can effectively correct the AM-AM error in the wireless communication circuit of FIG. 1;

FIG. 4 is a schematic diagram of an exemplary transceiver circuit configured to correct the AM-AM error in the wireless communication circuit based on the low-complexity AM-AM error correction scheme described in FIG. 3;

FIG. 5 is a schematic diagram of an exemplary user element (e.g., wireless device) wherein the transceiver circuit of FIG. 4 can be provided; and

FIG. 6 is a flowchart of an exemplary process for correcting an amplitude error in the user element of FIG. 5.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element or intervening elements may also be present. In contrast, when an element is referred to as being “directly on” or extending “directly onto” another element, there are no intervening elements present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises,” “comprising,” “includes,” and/or “including” when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Embodiments of the disclosure relate to low-complexity amplitude error correction in a wireless communication circuit. The wireless communication circuit includes a transceiver circuit, a power management integrated circuit (PMIC), and a power amplifier circuit(s). The transceiver circuit generates a radio frequency (RF) signal(s) from an input vector, the PMIC generates a modulated voltage, and the power amplifier circuit(s) amplifies the RF signal(s) based on the modulated voltage. When the power amplifier circuit(s) is coupled to an RF frontend circuit (e.g., filter/multiplexer), an output reflection coefficient (e.g., S₂₂) of the power amplifier circuit(s) can interact with an input reflection coefficient (e.g., S₁₁) of the RF frontend circuit to create a voltage distortion filter on an output stage of the power amplifier circuit(s), which can cause an unwanted amplitude-amplitude (AM-AM) error across a modulation bandwidth of the wireless communication circuit.

In this regard, in embodiments disclosed herein, the transceiver circuit is configured to equalize the input vector to thereby correct the AM-AM error across the modulation bandwidth. Unlike conventional methods where complicated memory digital predistortion (mDPD) coefficients must be defined and calibrated for each modulation frequency within the modulation bandwidth, the transceiver circuit is configured herein to eliminate modulation frequency dependency of the AM-AM error. As a result, it is possible to correct the AM-AM error across the modulation bandwidth with reduced complexity to thereby improve efficiency and linearity of the wireless communication circuit.

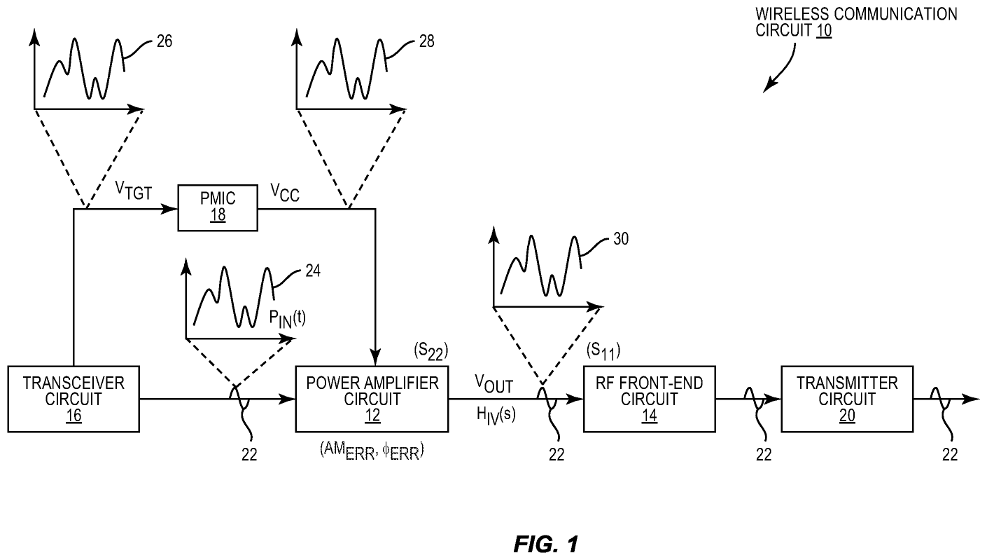

FIG. 1 is a schematic diagram of an exemplary wireless communication circuit 10 (a.k.a. wireless device), wherein an unwanted voltage distortion filter H_{IV}(s) may cause an AM-AM error in a power amplifier circuit 12 when the power amplifier circuit 12 is coupled to a radio frequency (RF) frontend circuit 14. Notably, in the unwanted voltage distortion filter H_{IV}(s), “s” is a notation of Laplace transform. The wireless communication circuit 10 includes a transceiver circuit 16, and a power management integrated circuit (PMIC) 18, and a transmitter circuit 20, which can include an antenna(s) (not shown) as an example.

The transceiver circuit 16 is configured to generate an RF signal 22 having a time-variant input power PIN(t) that corresponds to a time-variant voltage envelope 24 and provides the RF signal 22 to the power amplifier circuit 12. The transceiver circuit 16 is also configured to generate a time-variant target voltage V_{TGT}, which is associated with a time-variant target voltage envelope 26 that tracks the time-variant voltage envelope 24 of the RF signal 22. The PMIC 18 is configured to generate a modulated voltage V_{CC} having a time-variant modulated voltage envelope 28 (e.g., an average power tracking voltage) that tracks the time-variant target voltage envelope 26 of the time-variant target voltage V_{TGT} and provides the modulated voltage V_{CC} to the power amplifier circuit 12. The power amplifier circuit 12 is configured to amplify the RF signal 22 based on the modulated voltage V_{CC} to a time-variant output voltage V_{OUT} associated with a time-variant output voltage envelope 30. The power amplifier circuit 12 then provides the amplified RF signal 22 to the RF frontend circuit 14. The RF frontend circuit 14 may be a filter circuit that performs further frequency filtering on the amplified RF signal 22 before providing the amplified RF signal 22 to the transmitter circuit 20 for transmission.

When the power amplifier circuit 12 is coupled to the RF frontend circuit 14, the unwanted voltage distortion filter H_{IV}(s) can cause a frequency-dependent AM-AM error across all modulation frequencies across the modulation bandwidth. For a detailed analysis as to how the unwanted voltage distortion filter H_{IV}(s) can be created by the coupling of the power amplifier circuit 12 and the RF frontend circuit 14, please refer to U.S. patent application Ser. No. 17/939,350, entitled “PHASE AND AMPLITUDE ERROR CORRECTION IN A TRANSMISSION CIRCUIT.”

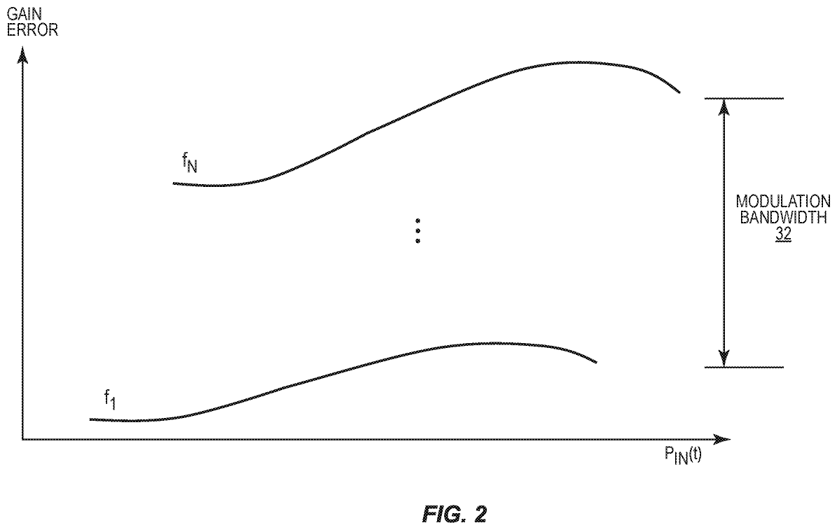

FIG. 2 is a graphic diagram illustrating a distribution of the AM-AM error across an entire modulation bandwidth 32 of the wireless communication circuit 10 of FIG. 1. The modulation bandwidth 32 includes multiple modulation frequencies f₁-f_{N}. Each of the modulation frequencies f₁-f_{N} corresponds to a respective time-variant gain error that is dependent on the time-variant input power P_{IN}(t). In other words, the gain error has a dependency on both the modulation frequencies f₁-F_{N} and the time-variant input power P_{IN}(t).

A conventional approach for correcting such gain error is to employ a memory digital predistortion (mDPD) circuit in the transceiver circuit 16 to inject a gain error correction term into the RF signal 22. However, given the frequency and power dependency of the gain error, the mDPD circuit must define and calibrate a respective set of complex coefficients for each of the modulation frequencies f₁-f_{N}. Notably, to operate in a fifth generation (5G) or a 5G new-radio (5G-NR) system, the wireless communication circuit 10 often needs to support a wide modulation bandwidth (e.g., >200 MHZ). As such, a number of the modulation frequencies f₁-f_{N} can increase significantly, thus leading to a significantly increased complexity with respect to implementation and calibration of the mDPD coefficients. Hence, it is desirable to enhance the wireless communication circuit 10 based on a low-complexity AM-AM error correction scheme to effectively correct the gain error across the entire modulation bandwidth 32.

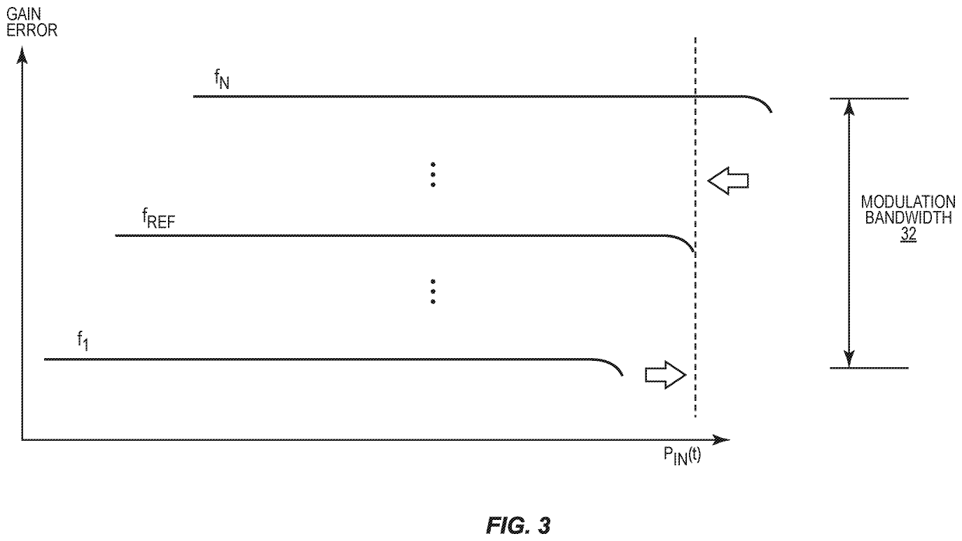

FIG. 3 is a graphic diagram illustrating a low-complexity AM-AM error correction scheme that can effectively correct the AM-AM error in the wireless communication circuit 10 of FIG. 1. Herein, the low-complexity AM-AM correction scheme is able to reduce complexity associated with AM-AM error correction by eliminating modulation frequency dependency of the gain error.

First of all, the gain error associated with each of the modulation frequencies f₁-f_{N} is first linearized with respect to the time-variant input power P_{IN}(t). As shown in FIG. 3, the linearized gain error associated with each of the modulation frequencies f₁-f_{N} is independent from the time-variant input power P_{IN}(t).

Next, a reference modulation frequency f_{REF} among the modulation frequencies f₁-f_{N} is chosen and a set of linearized gain error correction terms is defined for the reference modulation frequency f_{REF}. In a non-limiting example, the reference modulation frequency f_{REF} can be a center modulation frequency among the modulation frequencies f₁-f_{N}.

Subsequently, the linearized gain error of any selected one of the modulation frequencies f₁-f_{N} can be superimposed onto the linearized gain error of the reference modulation frequency f_{REF}. Herein, the phrase “superimposing” refers to a process for determining an appropriate x-axis shift (e.g., a vector) to align a respective linearized gain error of any selected one of the modulation frequencies f₁-f_{N} with the respective linearized gain error of the reference modulation frequency f_{REF}.

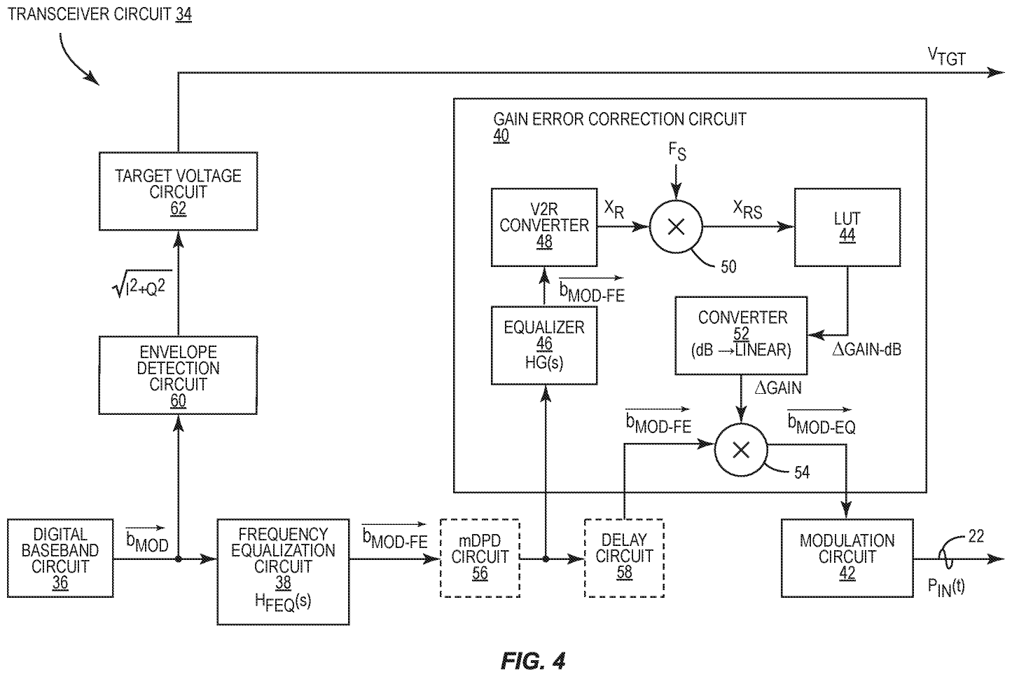

As shown in FIG. 3, superimposing the linearized gain error of the modulation frequency f₁ onto the linearized gain error of the reference modulation frequency f_{REF} is equivalent to shifting the linearized gain error of the modulation frequency f₁ rightward along the x-axis. Likewise, superimposing the linearized gain error of the modulation frequency f_{N} onto the linearized gain error of the reference modulation frequency f_{REF} is equivalent to shifting the linearized gain error of the modulation frequency f_{N} leftward along the x-axis. By superimposing the linearized gain error of each of the modulation frequencies f₁-f_{N} onto the linearized gain error of the reference modulation frequency f_{REF}, it is possible to determine a respective linearized gain error correction term for each of the modulation frequencies f₁-f_{N} based on the set of linearized gain error correction terms defined for the reference modulation frequency f_{REF}. In this regard, the complexity associated with AM-AM error correction only revolves around the reference modulation frequency f_{REF}, as opposed to having to involve all the modulation frequencies f₁-f_{N}. As a result, the low-complexity AM-AM error correction scheme, as further described in FIG. 4 below, is clearly advantageous over the conventional methods where complicated mDPD coefficients must be defined and calibrated for each of the modulation frequencies f₁-f_{N}.

FIG. 4 is a schematic diagram of an exemplary transceiver circuit 34 configured to correct the AM-AM error in the wireless communication circuit 10 based on the low-complexity AM-AM error correction scheme described in FIG. 3. The transceiver circuit 34 can be provided in the wireless communication circuit 10 to replace the transceiver circuit 16. By replacing the transceiver circuit 16 with the transceiver circuit 34, the wireless communication circuit 10 can be adapted to support the low-complexity AM-AM error correction scheme of the present disclosure.

The transceiver circuit 34 includes a digital baseband circuit 36, a frequency equalization circuit 38, a gain error correction circuit 40, and a modulation circuit 42. In an embodiment, the gain error correction circuit 40 includes a lookup table (LUT) circuit 44, which may be preprogrammed to store a set of decibel gain error correction terms ΔGain-dB associated with the reference modulation frequency f_{REF}. As previously described in FIG. 3, each of the modulation frequencies f₁-f_{N} can be superimposed on the reference modulation frequency f_{REF} by shifting a respective one of the modulation frequencies f₁-f_{N} leftward or rightward. In this regard, in a non-limiting example, the LUT circuit 44 can be programmed to correlate different amounts of a leftward or rightward shift with different decibel gain error correction terms ΔGain-dB. As such, once the amount of the leftward or rightward shift associated with a respective one of the modulation frequencies f₁-f_{N} is determined, the LUT circuit 44 will be able to provide a corresponding decibel gain error correction term ΔGain-dB for the respective one of the modulation frequencies f₁-f_{N}.

The digital baseband circuit 36 is configured to generate an input vector \vec{b_{MOD}} in a selected modulation frequency among the modulation frequencies f₁-f_{N} across the modulation bandwidth 32. The frequency equalization circuit 38 is configured to apply a frequency equalization filter H_{FEQ}(s) to the input vector \vec{b_{MOD}} to generate a frequency-equalized input vector \vec{b_{MOD-FE}}, in which the respective gain error in each of the modulation frequencies f₁-f_{N} is linearized. As previously illustrated in FIG. 3, the linearized gain error associated with each of the modulation frequencies f₁-f_{N} becomes independent from the time-variant input power P_{IN}(t).

In an embodiment, the gain error correction circuit 40 includes an equalizer circuit 46, a vector-to-real (V2R) converter 48, a scaler 50, a converter circuit 52, and a multiplier circuit 54. The equalizer circuit 46 is configured to apply a complex filter HG(s) to the frequency-equalized input vector \vec{b_{MOD-FE}} to superimpose the respective linearized gain error in a selected one of the modulation frequencies f₁-f_{N} onto the respective linearized gain error in the reference modulation frequency f_{REF}.

The V2R converter 48 is configured to extract a real parameter X_{R} from the superimposed frequency-equalized input vector \vec{b_{MOD-FE}}. The scaler 50 may be configured to scale the real parameter X_{R} based on a scaling factor Fs to generate a scaled real parameter X_{RS}. According to an embodiment of the present disclosure, the scaled real parameter X_{RS} represents an amount of the leftward (e.g., a negative number) or rightward (e.g., a positive number) shift that is required to superimpose the linearized gain error of the selected one of the modulation frequencies f₁-f_{N} onto the linearized gain error of the reference modulation frequency f_{REF}. Understandably, if the selected one of the modulation frequencies f₁-f_{N} is the same as the reference modulation frequency f_{REF}, then the leftward or rightward shift will not be needed.

Based on the scaled real parameter X_{RS}, the LUT circuit 44 is able to determine a corresponding decibel gain error correction term ΔGain-dB in the reference modulation frequency f_{REF}. The converter circuit 52 then converts the decibel gain error correction term ΔGain-dB into a linearized gain error correction term ΔGain for the selected one of the modulation frequencies f₁-f_{N}. Accordingly, the multiplier circuit 54 can multiply the linearized gain error correction term ΔGain with the frequency-equalized input vector \vec{b_{MOD-FE}} to thereby generate an equalized input vector \vec{b_{MOD-EQ}} that can correct the AM-AM error in the power amplifier circuit 12 in FIG. 1. Subsequently, the modulation circuit 42 can convert the equalized input vector \vec{b_{MOD-EQ}} into the RF signal 22 and modulate the RF signal 22 onto an intermediate frequency (IF) or a carrier frequency.

The transceiver circuit 34 may include an mDPD circuit 56. In an embodiment, the mDPD circuit 56 can be configured to correct any residual gain error in the equalized input vector \vec{b_{MOD-EQ}}. The transceiver circuit 34 may also include a delay circuit 58, which can be configured to delay the frequency-equalized input vector \vec{b_{MOD-FE}} to compensate for a group delay associated with the gain error correction circuit 40.

The transceiver circuit 34 further includes an envelope detection circuit 60 and a target voltage circuit 62. The envelope detection circuit 60 is configured to detect a time-variant amplitude envelope \sqrt{I²+Q²} of the input vector \vec{b_{MOD}}, wherein “I” and “Q” represent an in-phase component and a quadrature component of the input vector \vec{b_{MOD}}, respectively. The target voltage circuit 62 is configured to generate the time-variant target voltage V_{TGT} that keeps track of the time-variant amplitude envelope \sqrt{I²+Q²} of the input vector \vec{b_{MOD}}.

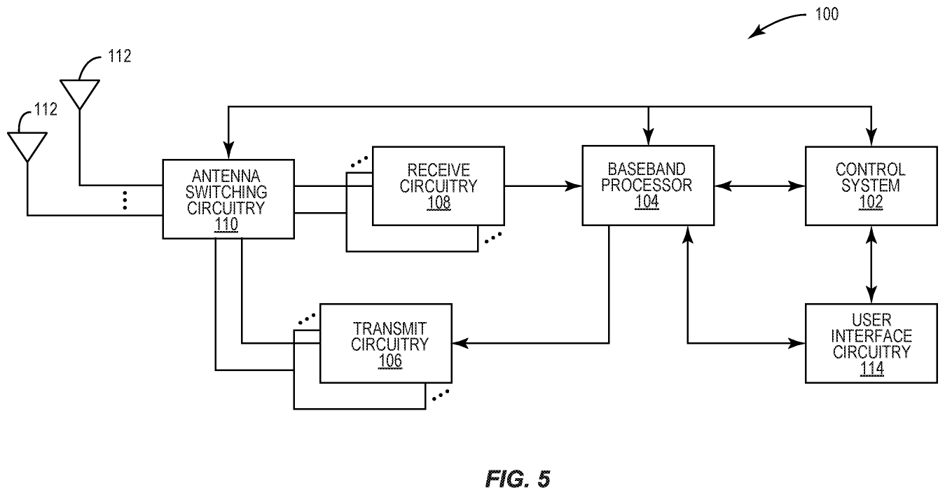

The transceiver circuit 34 of FIG. 4 can be provided in a user element (e.g., wireless device) to provide the low-complexity AM-AM error correction according to the embodiments described above. In this regard, FIG. 5 is a schematic diagram of an exemplary user element 100 wherein the transceiver circuit 34 of FIG. 4 can be provided.

Herein, the user element 100 can be any type of user elements, such as mobile terminals, smart watches, tablets, computers, navigation devices, access points, and like wireless communication devices that support wireless communications, such as cellular, wireless local area network (WLAN), Bluetooth, and near field communications. The user element 100 will generally include a control system 102, a baseband processor 104, transmit circuitry 106, receive circuitry 108, antenna switching circuitry 110, multiple antennas 112, and user interface circuitry 114. In a non-limiting example, the control system 102 can be a field-programmable gate array (FPGA), as an example. In this regard, the control system 102 can include at least a microprocessor(s), an embedded memory circuit(s), and a communication bus interface(s). The receive circuitry 108 receives radio frequency signals via the antennas 112 and through the antenna switching circuitry 110 from one or more base stations. A low noise amplifier and a filter cooperate to amplify and remove broadband interference from the received signal for processing. Downconversion and digitization circuitry (not shown) will then downconvert the filtered, received signal to an intermediate or baseband frequency signal, which is then digitized into one or more digital streams using analog-to-digital converter(s) (ADC).

The baseband processor 104 processes the digitized received signal to extract the information or data bits conveyed in the received signal. This processing typically comprises demodulation, decoding, and error correction operations, as will be discussed in greater detail below. The baseband processor 104 is generally implemented in one or more digital signal processors (DSPs) and application specific integrated circuits (ASICs).

For transmission, the baseband processor 104 receives digitized data, which may represent voice, data, or control information, from the control system 102, which it encodes for transmission. The encoded data is output to the transmit circuitry 106, where a digital-to-analog converter(s) (DAC) converts the digitally encoded data into an analog signal and a modulator modulates the analog signal onto a carrier signal that is at a desired transmit frequency or frequencies. A power amplifier will amplify the modulated carrier signal to a level appropriate for transmission, and deliver the modulated carrier signal to the antennas 112 through the antenna switching circuitry 110. The multiple antennas 112 and the replicated transmit and receive circuitries 106, 108 may provide spatial diversity. Modulation and processing details will be understood by those skilled in the art.

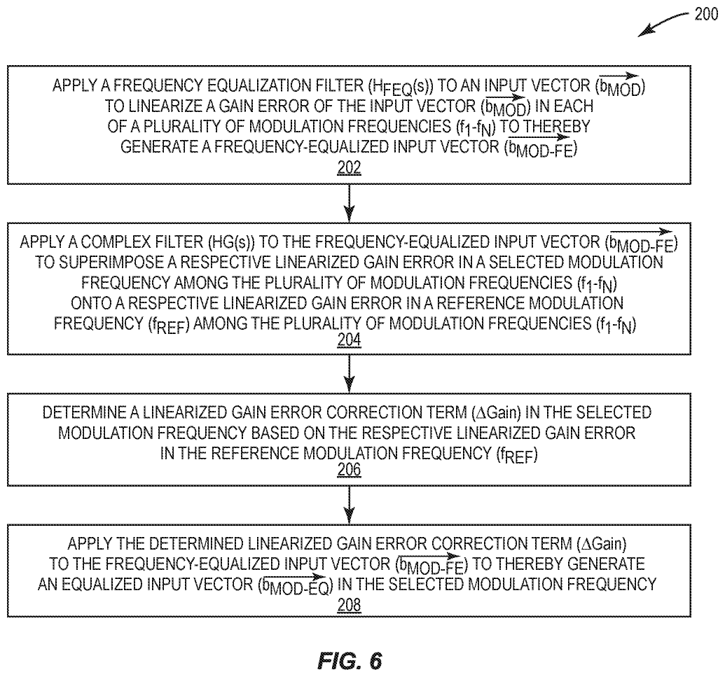

The user element 100 of FIG. 5 can be configured to correct amplitude error based on a process. In this regard, FIG. 6 is a flowchart of an exemplary process 200 for correcting amplitude error in the user element 100 of FIG. 5.

Specifically, the process 200 includes applying the frequency equalization filter H_{FEQ}(s) to the input vector \vec{b_{MOD}} to linearize the gain error of the input vector \vec{b_{MOD}} in each of the modulation frequencies f₁-f_{N} to thereby generate the frequency-equalized input vector \vec{b_{MOD-FE}} (step 202). The process 200 also includes applying the complex filter HG(s) to the frequency-equalized input vector \vec{b_{MOD-FE}} to superimpose the respective linearized gain error in the selected modulation frequency among the modulation frequencies (f₁-f_{N}) onto the respective linearized gain error in the reference modulation frequency f_{REF} among the modulation frequencies f₁-f_{N} (step 204). The process 200 also includes determining the linearized gain error correction term ΔGain in the selected modulation frequency based on the respective linearized gain error in the reference modulation frequency f_{REF} (step 206). The process 200 also includes applying the determined linearized gain error correction term ΔGain to the frequency-equalized input vector \vec{b_{MOD-FE}} to thereby generate the equalized input vector \vec{b_{MOD-EQ}} in the selected modulation frequency (step 208).

Those skilled in the art will recognize improvements and modifications to the preferred embodiments of the present disclosure. All such improvements and modifications are considered within the scope of the concepts disclosed herein and the claims that follow.

What is claimed is:

1. A transceiver circuit comprising:
a frequency equalization circuit configured to apply a frequency equalization filter to an input vector to linearize a gain error of the input vector in each of a plurality of modulation frequencies to thereby generate a frequency-equalized input vector; and
a gain error correction circuit configured to:
apply a complex filter to the frequency-equalized input vector to superimpose a respective linearized gain error in a selected modulation frequency among the plurality of modulation frequencies onto a respective linearized gain error in a reference modulation frequency among the plurality of modulation frequencies;
determine a linearized gain error correction term in the selected modulation frequency based on the respective linearized gain error in the reference modulation frequency; and
apply the determined linearized gain error correction term to the frequency-equalized input vector to thereby generate an equalized input vector in the selected modulation frequency.

2. The transceiver circuit of claim 1, wherein the gain error correction circuit comprises:
an equalizer circuit configured to apply the complex filter to the frequency-equalized input vector to superimpose the respective linearized gain error in the selected modulation frequency onto the respective linearized gain error in the reference modulation frequency;
a vector-to-real (V2R) converter configured to extract a real parameter from the superimposed frequency-equalized input vector, wherein the real parameter indicates an amount of shift that is required to superimpose the respective linearized gain error in the selected modulation frequency onto the respective linearized gain error in the reference modulation frequency;
a scaler configured to scale the real parameter based on a scaling factor to thereby generate a scaled real parameter;
a lookup table (LUT) circuit configured to determine a decibel gain error correction term in the reference modulation frequency based on the scaled real parameter;
a converter circuit configured to convert the decibel gain error correction term into the linearized gain error correction term; and
a multiplier circuit configured to multiply the linearized gain error correction term with the frequency-equalized input vector to thereby generate the equalized input vector.

3. The transceiver circuit of claim 1, further comprising a digital baseband circuit configured to generate the input vector in the selected modulation frequency.

4. The transceiver circuit of claim 1, further comprising a modulation circuit configured to convert the equalized input vector into a radio frequency (RF) signal and modulate the RF signal onto one of an intermediate frequency and a carrier frequency.

5. The transceiver circuit of claim 1, further comprising a memory digital predistortion (mDPD) circuit configured to correct a residual gain error in the equalized input vector.

6. The transceiver circuit of claim 1, further comprising a delay circuit configured to delay the frequency-equalized input vector to compensate for a group delay associated with the gain error correction circuit.

7. The transceiver circuit of claim 1, further comprising:
a digital baseband circuit configured to generate the input vector in the selected modulation frequency;
a modulation circuit configured to convert the equalized input vector into a radio frequency (RF) signal and modulate the RF signal onto one of an intermediate frequency and a carrier frequency;
a memory digital predistortion (mDPD) circuit configured to correct a residual gain error in the equalized input vector; and
a delay circuit configured to delay the frequency-equalized input vector to compensate for a group delay associated with the gain error correction circuit.

8. The transceiver circuit of claim 1, wherein the reference modulation frequency is a center modulation frequency among the plurality of modulation frequencies.

9. The transceiver circuit of claim 1, further comprising:
an envelope detection circuit configured to detect a time-variant amplitude envelope of the input vector; and
a target voltage circuit configured to generate a time-variant target voltage envelope that keeps track of the time-variant amplitude envelope of the input vector.

10. A wireless device comprising a transceiver circuit comprising:
a frequency equalization circuit configured to apply a frequency equalization filter to an input vector to linearize a gain error of the input vector in each of a plurality of modulation frequencies to thereby generate a frequency-equalized input vector; and
a gain error correction circuit configured to:
apply a complex filter to the frequency-equalized input vector to superimpose a respective linearized gain error in a selected modulation frequency among the plurality of modulation frequencies onto a respective linearized gain error in a reference modulation frequency among the plurality of modulation frequencies;
determine a linearized gain error correction term in the selected modulation frequency based on the respective linearized gain error in the reference modulation frequency; and
apply the determined linearized gain error correction term to the frequency-equalized input vector to thereby generate an equalized input vector in the selected modulation frequency.

11. The wireless device of claim 10, wherein the gain error correction circuit comprises:
an equalizer circuit configured to apply the complex filter to the frequency-equalized input vector to superimpose the respective linearized gain error in the selected modulation frequency onto the respective linearized gain error in the reference modulation frequency;
a vector-to-real (V2R) converter configured to extract a real parameter from the superimposed frequency-equalized input vector, wherein the real parameter indicates an amount of shift that is required to superimpose the respective linearized gain error in the selected modulation frequency onto the respective linearized gain error in the reference modulation frequency;
a scaler configured to scale the real parameter based on a scaling factor to thereby generate a scaled real parameter;
a lookup table (LUT) circuit configured to determine a decibel gain error correction term in the reference modulation frequency based on the scaled real parameter;
a converter circuit configured to convert the decibel gain error correction term into the linearized gain error correction term; and
a multiplier circuit configured to multiply the linearized gain error correction term with the frequency-equalized input vector to thereby generate the equalized input vector.

12. The wireless device of claim 10, wherein the transceiver circuit further comprises a digital baseband circuit configured to generate the input vector in the selected modulation frequency.

13. The wireless device of claim 10, wherein the transceiver circuit further comprises a modulation circuit configured to convert the equalized input vector into a radio frequency (RF) signal and modulate the RF signal onto one of an intermediate frequency and a carrier frequency.

14. The wireless device of claim 10, wherein the transceiver circuit further comprises a memory digital predistortion (mDPD) circuit configured to correct a residual gain error in the equalized input vector.

15. The wireless device of claim 10, wherein the transceiver circuit further comprises a delay circuit configured to delay the frequency-equalized input vector to compensate for a group delay associated with the gain error correction circuit.

16. The wireless device of claim 10, wherein the transceiver circuit further comprises:
a digital baseband circuit configured to generate the input vector in the selected modulation frequency;
a modulation circuit configured to convert the equalized input vector into a radio frequency (RF) signal and modulate the RF signal onto one of an intermediate frequency and a carrier frequency;
a memory digital predistortion (mDPD) circuit configured to correct a residual gain error in the equalized input vector; and
a delay circuit configured to delay the frequency-equalized input vector to compensate for a group delay associated with the gain error correction circuit.

17. The wireless device of claim 16, wherein the transceiver circuit further comprises:
an envelope detection circuit configured to detect a time-variant amplitude envelope of the input vector; and
a target voltage circuit configured to generate a time-variant target voltage envelope that keeps track of the time-variant amplitude envelope of the input vector.

18. The wireless device of claim 17, further comprising:
a power management integrated circuit (PMIC) configured to generate a modulated voltage having a time-variant modulated voltage envelope that tracks the time-variant target voltage envelope; and
a power amplifier circuit configured to amplify the RF signal based on the modulated voltage.

19. The wireless device of claim 10, wherein the reference modulation frequency is a center modulation frequency among the plurality of modulation frequencies.

20. A method for correcting an amplitude error in a wireless device comprising:
applying a frequency equalization filter to an input vector to linearize a gain error of the input vector in each of a plurality of modulation frequencies to thereby generate a frequency-equalized input vector;
applying a complex filter to the frequency-equalized input vector to superimpose a respective linearized gain error in a selected modulation frequency among the plurality of modulation frequencies onto a respective linearized gain error in a reference modulation frequency among the plurality of modulation frequencies;
determining a linearized gain error correction term in the selected modulation frequency based on the respective linearized gain error in the reference modulation frequency; and
applying the determined linearized gain error correction term to the frequency-equalized input vector to thereby generate an equalized input vector in the selected modulation frequency.
